(19) United States
(12) Patent Application Publication
(10) Pub. No.: US 2002/0096896 A1
(43) Pub. Date: Jul. 25, 2002

(54) Combined type stainless steel chopstick

(76) Inventor: Yin-Chu Lai, Changhua (TW)

Correspondence Address: Dougherty & Troxell, ONE SKYLINE PLACE, SUITE 1404, 5205 LEESBURG PIKE, FALLS CHURCH, VA, 22041, US

(21) Appl. No.: 09/764,269

(22) Filed: Jan. 19, 2001

(51) Int. Cl. A01B 1/22

(52) U.S. Cl. 294/58

(57) ABSTRACT

A combined type stainless steel chopstick formed by at least two materials is disclosed. The chopstick is formed by tightly combining a holding body with a stainless steel cover, and a front section of the stainless steel cover has a textured surface. The cleaning work is easy, and the cambered edge causes no residue left on the chopstick. Moreover, the defect of generating bacterial on the chopstick as that in the prior art chopstick is improved. The chopstick is made of at least two materials so that the holding sense is preferred, further, since the clamping portion has a textured surface, the clamping effect is good.

### FIELD OF THE INVENTION

The present invention relates to a combined type stainless steel chopstick having a good holding feeling, cleaned easily and formed by at least two stainless steel materials, moreover, the present invention provide a combined type stainless steel chopstick providing a good clamping force so that the food can be clamped tightly.

### BACKGROUND OF THE INVENTION

Chopsticks are widely used in East Asia, however, chopsticks are slender long rods with the same length. The rod has a round shape or a square shape or has a round a square lower section and a tapered lower section as a clamping portion.

All the chopsticks have a structure approximately like the aforesaid one, the difference therebetween are materials, such as plastic, wood, or stainless steel, etc. Washless wood chopsticks used only once is waste. However, if it is washed to be used again, it is easy to generate bacterial. The portion for clamping foods contacts food directly so as to be possible to become a threat to the human health. The chopsticks made of plastics have a smooth surface so that the clamped force is weak although it may prevent from generating bacterial. The stainless steel chopsticks have bad holding feeling and the surface thereof is too smooth so that the foods can not be clamped well. Furthermore, the holding portion is cool so that the holding feel is not bad. Besides, stainless steel chopsticks are hard in manufacturing.

Therefore, there is an eager demand for novel designed chopsticks which may improve the aforesaid defects and thus, provide a good holding feeling, and cleaned easily

### SUMMARY OF THE INVENTION

Accordingly, the primary object of the present invention is to provide a combined type stainless steel chopstick having a good holding feeling, cleaned easily and formed by at least two stainless steel materials.

Another object of the present invention is to provide a combined type stainless steel chopstick providing a good clamping force so that the food can be clamped tightly.

A further object of the present invention is to provide a combined type stainless steel chopstick having a variable beautiful outlook.

To achieve above objects, the present invention provides a combined type stainless steel chopstick formed by at least two materials. The chopstick is formed by tightly combining a holding body and a stainless steel cover, a front section of the stainless steel cover has a textured surface. The cleaning work is easy, and the cambered edge causes no residue left on the chopstick. Moreover, the defect of generating bacterial on the chopstick as that in the prior art chopstick is improved. The chopstick is made of at least two materials so that the holding sense is preferred, further, since the clamping portion has a textured surface so that the clamping effect is good.

The various objects and advantages of the present invention will be more readily understood from the following detailed description when read in conjunction with the appended drawing.

### BRIEF DESCRIPTION OF THE DRAWINGS

FIG. 1 shows a perspective view of one embodiment in the present invention.

FIG. 2 is an exploded view of the components of the embodiment in the present invention.

FIG. 3 is an assembled cross sectional view of the embodiment according to the present invention.

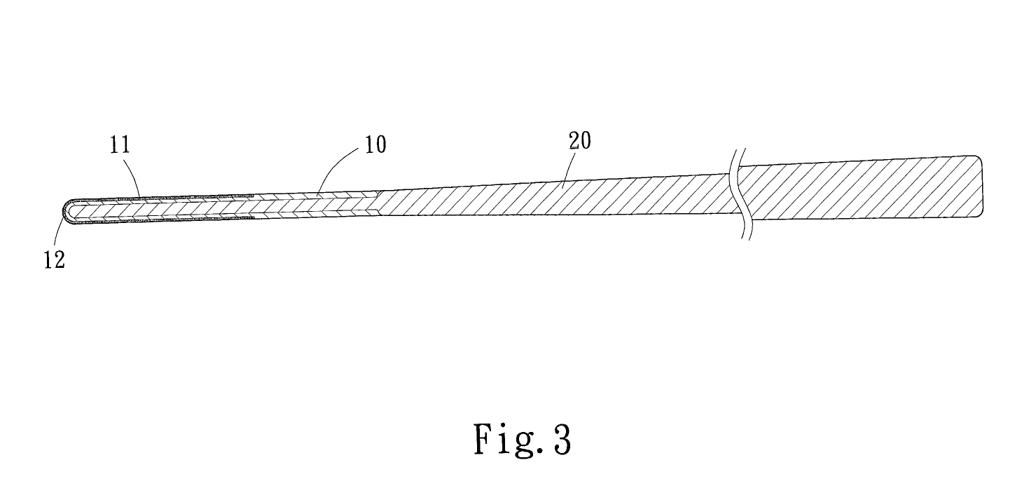

FIG. 4 is an assembled cross sectional view of another embodiment in the present invention.

FIG. 5 shows an application of the embodiment in the present invention.

FIG. 6 is a schematic view showing that a pattern is formed in the holding body of the embodiment in the present invention.

FIG. 7 is a perspective view showing another application of the embodiment in the present invention.

### DETAILED DESCRIPTION OF THE PREFERRED EMBODIMENTS

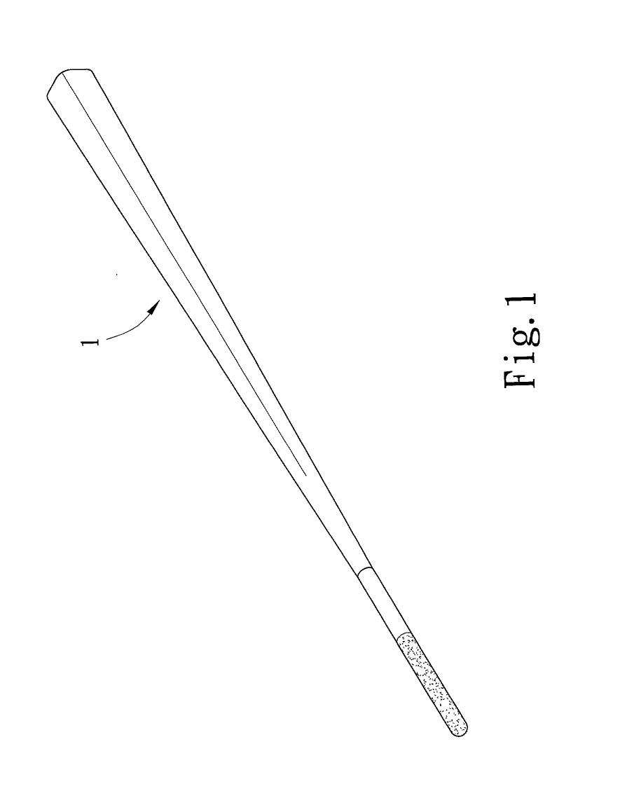

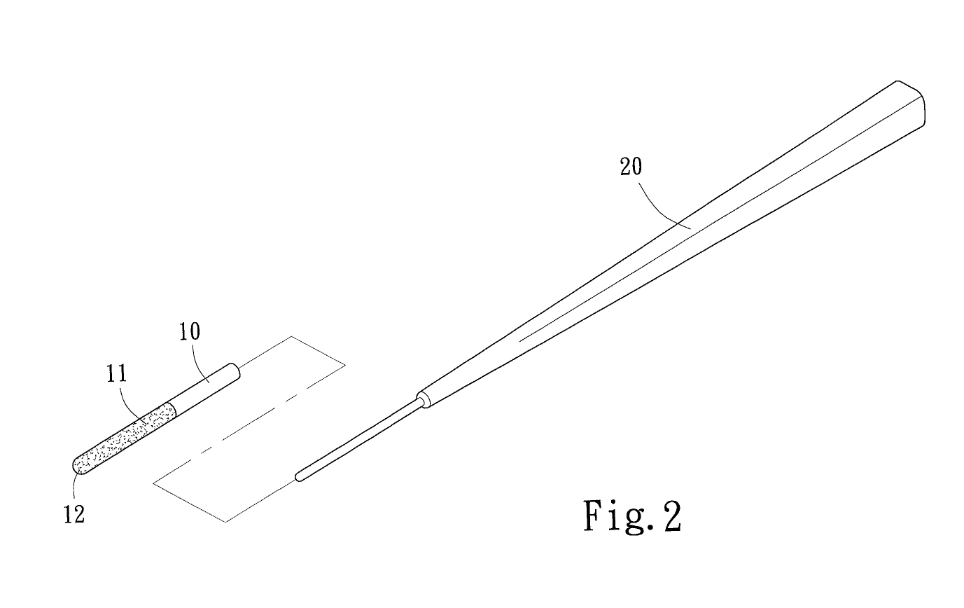

Referring to FIGS. 1, and 2, the chopstick 1 of the present invention is formed by combining a stainless steel cover 10 and a holding body 20. The stainless steel cover 10 is installed with a round cover having a proper length. The cover can be divided into two parts. A rear section is a smooth surface and the front section is a non-smooth textured surface 11. The front edge of stainless steel cover 10 has a cambered edge 12.

Thereby, the stainless steel cover 10 is placed into a mold. A holding body 20 is mold-injected by various materials (for example, Nylon, PP, ABS, ceramics, stone material, glass, general material, plastic sheet). Then, plastic material is injected into the stainless steel cover 10. By mold injection, the plastic is tightly combined with the stainless steel cover 10 and a high pressure is formed therebetween. Therefore, a holding body 20 is formed.

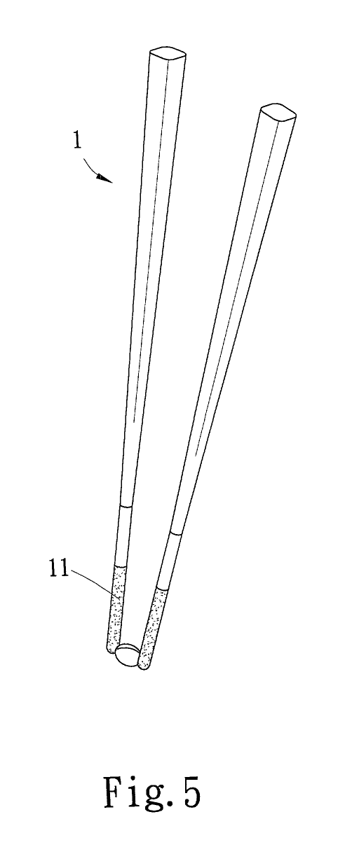

Referring to FIG. 5, as the chopsticks of the present invention is used, since the textured surface 11 in front section of the chopsticks provide a larger friction force, as a food is clamped, it may be clamped steadily.

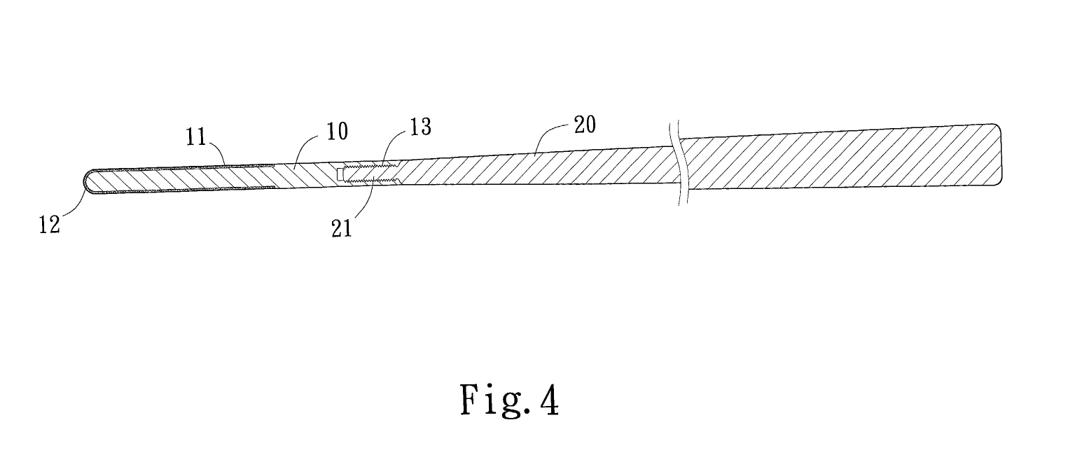

Furthermore, the distal end o the stainless steel cover 10 is formed with a screw hole 13. A front combining portion of the holding body 20 formed by mold-injection is formed with a threaded portion 21 so that the two threaded combined, as shown in FIG. 4. Therefore, a complete chopstick 1 is formed.

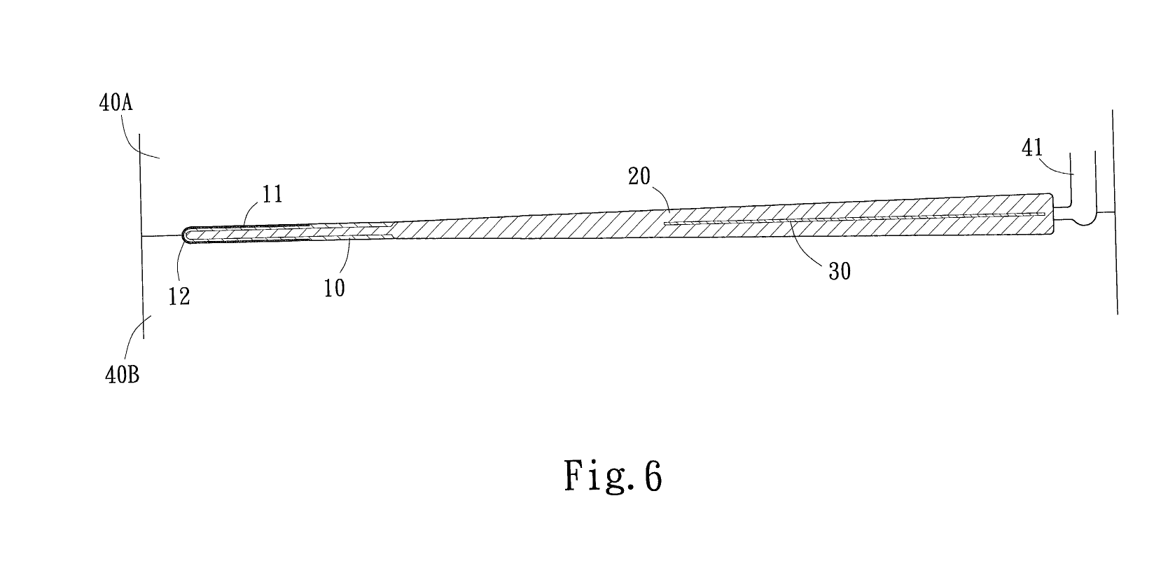

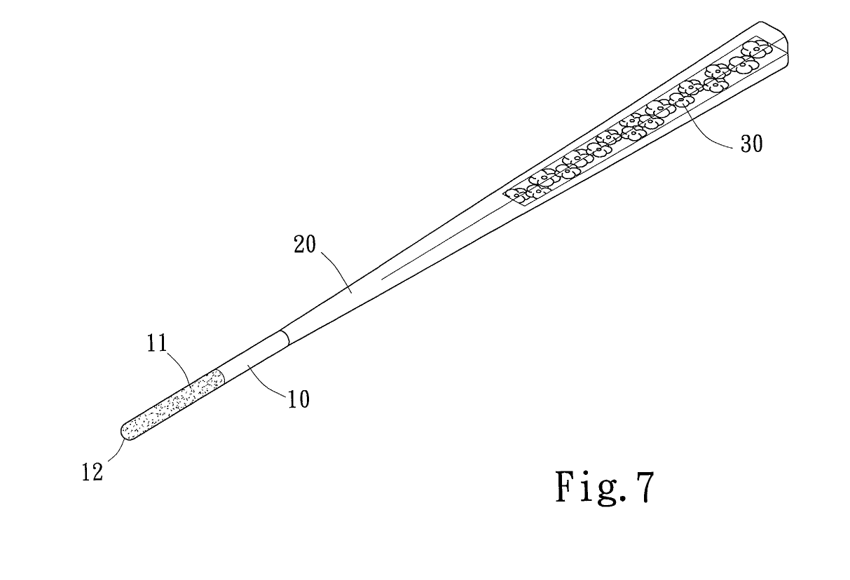

Moreover, the holding body 20 of the present invention can be formed by another way, as shown in FIG. 6. A piece body 30 is formed therein. The piece body 30 is machined by screen printing, etching or laser engraving, or other ways. A preset pattern is formed on the piece body. The piece body 30 is placed in the lower mold 40A. A front section of the lower mold 40A is preset a recess for being embedded by the stainless steel cover 10. Furthermore, after the lower mold 40A is combined with an upper mold 40B, plastic material is injected from the material filling opening 41 on the upper mold 40B so that the filling material is sufficiently filled into the recess. Another, by the high pressure of the injected material, air can be vented from the hole 12 so that the piece body 30 is enclosed in the transparent material by vacuum. With reference to FIG. 7, in the present invention, holding sense of the holding body is improved.

The stainless steel cover 10 of the present invention has the following advantages:

1. The chopstick is made of at least two materials so that the holding sense is preferred, further, since the clamping portion has a textured surface so that the clamping effect is good.

2. The clamping portion of the present invention is health and environment protected. A front section of the clamping portion is a texture surface so that the friction force in clamp foods is larger and thus the foods are difficult to drop down.

3. A holding body is mold-injected by various materials, for example, Nylon, PP, ABS, ceramics, stone material, glass, general material, plastic sheet, or is enclosed in a transparent material by a piece body with preset pattern so as to present a beautiful outlook.

4. The cleaning work is easy, and the cambered edge causes no residue left on the chopstick. Moreover, the defect of generating bacterial on the chopstick as that in the prior art chopstick is improved.

5. The stainless steel cover is threaded with a holding body having different texture so that the types of chopsticks are varied.

The present invention is thus described, it will be obvious that the same may be varied in many ways. Such variations are not to be regarded as a departure from the spirit and scope of the present invention, and all such modifications as would be obvious to one skilled in the art are intended to be included within the scope of the following claims.

What is claimed is:

1. A combined type stainless steel chopstick formed by at least two materials, characteristic in that: the chopstick is formed by tightly combining a holding body and a stainless steel cover, a front section of the stainless steel cover has a textured surface.

2. The combined type stainless steel chopstick as claimed in claim 1, wherein the texture surface of the stainless steel cover is formed by machining a non-smooth stainless steel surface.

3. The combined type stainless steel chopstick as claimed in claim 1, wherein the holding body is formed by injection molding and by the high pressure in injection, the holding body is tightly combined with the stainless steel cover.

4. The combined type stainless steel chopstick as claimed in claim 1, wherein a combining end of the holding body is formed with thread for being screwedly connected to a hole at a distal end of the stainless steel cover.

5. The combined type stainless steel chopstick as claimed in claim 1, wherein the holding body is preinstalled with a piece body having a preset pattern.

6. The combined type stainless steel chopstick as claimed in claim 1, wherein a front edge of the stainless steel cover is formed with a round edge.

7. The combined type stainless steel chopstick as claimed in claim 1, wherein the holding body is mold-injected one material selected from a group containing Nylon, PP, ABS, ceramics, stone material, glass, general material, and plastic sheet.
